(19) United States
(12) Patent Application Publication
(10) Pub. No.: US 2013/0011324 A1
(43) Pub. Date: Jan. 10, 2013

(54) Process For The Production Of Hydrogen And Carbon Dioxide Utilizing Magnesium Based Sorbents In A Fluidized Bed

(75) Inventor: Bhadra S. Grover, Sugar Land, TX (US)

(73) Assignee: L'Air Liquide Societe Anonyme Pour L'Etude Et L'Exploitation Des Procedes Georges Claude, Paris (FR)

(21) Appl. No.: 13/176,376

(22) Filed: Jul. 5, 2011

(51) Int. Cl. C01B 31/20

(52) U.S. Cl. 423/437.1

(57) ABSTRACT

The present invention provides a process for recovering hydrogen and high pressure high purity carbon dioxide from one or more hydrocarbon feed streams utilizing a carbon dioxide removal unit that contains sorbent beds of a magnesium based sorbent in a fluidized form.

### FIELD OF THE INVENTION

The present invention relates to an energy efficient process for recovering hydrogen along with high pressure and high temperature carbon dioxide utilizing a reformer unit, a water gas shift unit, and sorbent beds configured to allow for the use of a magnesium based sorbent that is transported and cycled to different sorption beds for the sorption and desorption of carbon dioxide.

### BACKGROUND

In the typical prior art steps for carbon dioxide removal and regeneration, a hydrocarbon feed stream is treated in a steam hydrocarbon reformer unit, a water gas shift unit and a pressure swing adsorption unit in order to obtain a pressure swing adsorption unit tail gas which must then be further treated in an additional process to remove the carbon dioxide present in the tail gas stream. In this schematic, the carbon dioxide is removed after the stream is treated in the hydrogen pressure swing adsorption unit.

A number of different products have been proposed for use in prior art methods for the removal of the carbon dioxide. However, most of the products used have to be regenerated at low pressure thereby resulting in the production of a carbon dioxide stream that is at low pressure. For example, U.S. Pat. No. 6,322,612 describes a pressure swing adsorption process for carbon dioxide removal. However, carbon dioxide is produced at low atmospheric or sub-atmospheric pressure. Solvent scrubbing processes such as the amine scrubbing process requires gas cooling below 40° C. thereby resulting in a loss of thermal efficiency. Sorbents such as zeolites have their capacities lowered at temperatures above about 200° C., and are strongly affected by the presence of moisture. In addition, sorbents such as calcium based sorbents and lithium based sorbents have been shown to adsorb carbon dioxide within the 200° C. to 400° C. temperature range but must be regenerated at low pressure and much higher temperatures (from 700° C. or greater) thereby requiring a large amount of regeneration energy.

New sorbents have been proposed for the removal of carbon dioxide. The publication “Novel Regenerable Magnesium Hydroxide Sorbent for CO₂ Capture at Warm Gas Temperatures” by Rajani V Siriwardane and R. W Stevens of NETL (hereinafter “Novel Regenerable Magnesium Hydroxide Sorbent for CO₂ Capture”) describes a sorbent based on Mg(OH)₂ that can capture carbon dioxide at temperatures from 200° C. to 315° C. and can regenerate carbon dioxide at 20 bar and from 375° C. to 400° C. The noted article indicates that this sorbent may be used in applications such as coal gasification systems. U.S. Pat. No. 7,314,847 sets forth a process for preparing this sorbent. These sorbents produce CO₂ streams at elevated pressure and temperature, however the CO₂ stream needs further treatment to remove contaminants.

Accordingly, while there are a variety of different sorbents and different processes for removing carbon dioxide, there still exists a need to provide for a process that allows for the economical recovery of hydrogen as well as carbon dioxide where it is possible to remove the carbon dioxide at high pressure.

### SUMMARY OF THE INVENTION

The present invention provides an energy efficient process for recovering hydrogen along with high temperature high pressure carbon dioxide from one or more hydrocarbon gas streams utilizing at least a reformer unit, a water gas shift reactor and a carbon dioxide removal unit, the carbon dioxide removal unit including a magnesium based sorbent in a fluidized form to capture the carbon dioxide. By incorporating such a sorbent as a part of a carbon dioxide recovery unit into the process, it is possible, if desirable, to provide a purge effluent gas that can be recycled to be mixed with the hydrocarbon feed supplied to the reformer unit. More specifically, by subjecting the water gas shift effluent to treatment in a carbon dioxide recovery unit that contains sorbent beds with each sorbent bed configured to allow for the use of such a magnesium based sorbent, it is possible to obtain a purge effluent gas that can be recycled to the reformer unit as supplemental feed while minimizing, if not eliminating, the need to compress the purge effluent gas while at the same time, offseting the quantity of steam that needs to be injected for the reforming unit by the amount of steam present in the purge effluent gas.

### BRIEF DESCRIPTION OF THE FIGURES

FIG. 1 provides a schematic of the process of the present invention which includes a purge phase.

### DETAILED DESCRIPTION OF THE INVENTION

The process of the present invention provides for the incorporation of a sorbent based carbon dioxide removal unit into a process for the production of high purity hydrogen and high purity carbon dioxide. By utilizing a solid sorbent based carbon dioxide removal unit in which the sorbent is transported and cycled to different beds for sorption and desorption of carbon dioxide, it is possible to effectively remove the carbon dioxide present from the water gas shift effluent produced in the reformer unit/water gas shift reactor thereby producing a concentrated carbon dioxide product at high temperature and high pressure while still efficiently recovering the hydrogen product. As used herein, the phrase “high pressure and high temperature” with regard to the resulting carbon dioxide stream refers to a carbon dioxide stream at a pressure from about 10 bar to about 30 bar and a temperature from about 375° C. to about 420° C. The sorbent in the bed is kept fluidized or moving to be able to transport it from one bed to another bed. Note that when the purity of the carbon dioxide product is not of a greater concern (where the desire is to have a carbon dioxide product with a purity that is greater than 95%) it is not necessary to include the purge phase as in the second embodiment.

The process of the present invention involves recovering high purity hydrogen and high purity carbon dioxide from one or more hydrocarbon feed streams utilizing a reformer unit in combination with a water gas shift reactor, a carbon dioxide removal unit comprising one or more sorbent beds in which a magnesium based sorbent is transported and cycled between different beds for sorption and desorption of carbon dioxide and a pressure swing adsorption unit. As used herein, the phrase “high purity carbon dioxide” refers to a carbon dioxide stream that contains greater than 90% carbon dioxide, preferably greater than 95% carbon dioxide and even more preferably, greater than 99% carbon dioxide. Furthermore, as used herein, the phrase “high purity hydrogen” refers to a hydrogen stream that contains greater than 90% hydrogen, preferably greater than 95% hydrogen and even more preferably, greater than 99% hydrogen.

More specifically, the process involves introducing one or more hydrocarbon feed streams into a reformer unit to generate a hydrogen rich effluent, treating the hydrogen rich effluent in a water gas shift reactor to obtain a water gas shift effluent, subjecting the water gas shift effluent to treatment in a carbon dioxide removal unit to produce a carbon dioxide depleted stream, an optional purge effluent gas and a carbon dioxide rich stream, introducing the carbon dioxide depleted stream into a hydrogen pressure swing adsorption unit to allow for the recovery of high purity hydrogen, recycling the purge effluent gas, if any, to the hydrocarbon feed stream as a supplemental feed, and withdrawing all or part of the high purity carbon dioxide as product.

Those of ordinary skill in the art will recognize that the carbon dioxide depleted stream and the purge effluent gas may also contain residual amounts of carbon dioxide as well as the other components that may be present in the original gas stream treated. As used herein, the phrase “residual amounts” when referring to the amounts of other components that may be present in the carbon dioxide depleted stream refers collectively to an amount that is less than about 5.0%, preferably less than about 3.0% and even more preferably less than about 1.0%.

The present process provides for two main embodiments: one embodiment that contains four phases, including a purge phase, and another embodiment that contains three phases, since no purge phase is necessary. As noted hereinbefore, the inclusion of the purge phase is in those instances where it is important to have a carbon dioxide purity that is equal to or greater than 95%. While both embodiments will be discussed herein, the main discussion will center on the embodiment where purity greater than 95% is desired. Note that in the embodiment where a purge phase is included, the sorbent is purged with steam to remove any entrained gases such as hydrogen, carbon monoxide, and methane that are carried over with the sorbent from the first sorbent bed. This increases the purity of carbon dioxide being recovered in the next step.

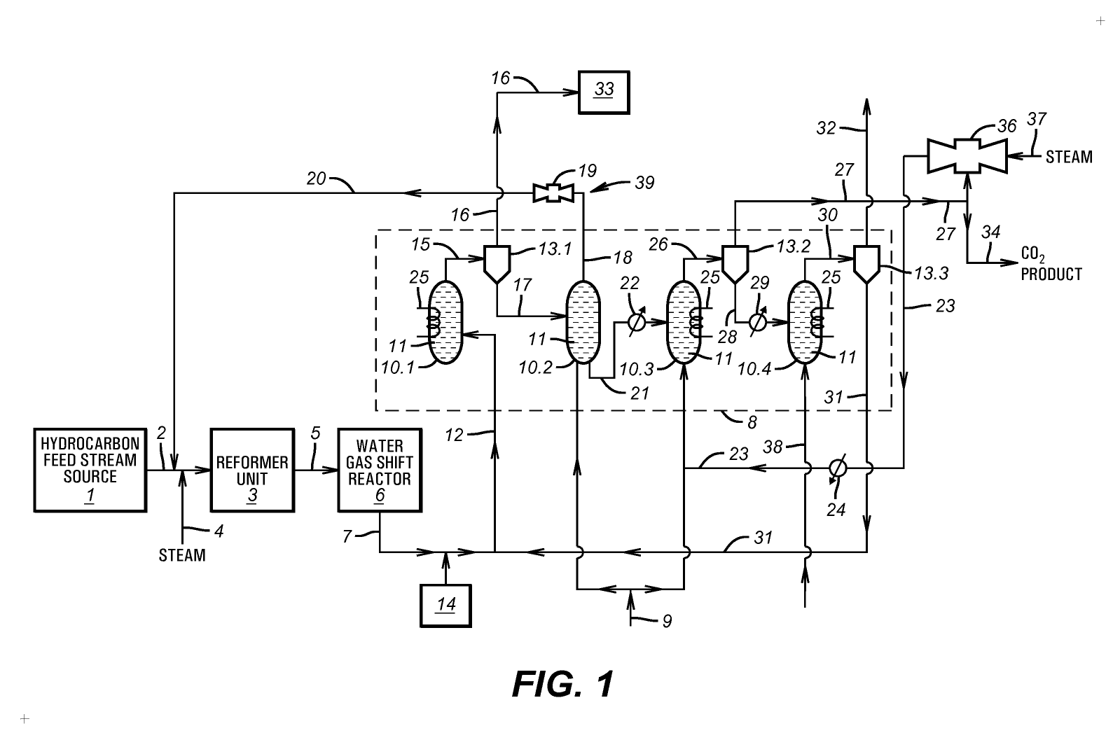

The present process will be further described with reference to the single FIGURE contained herein (FIG. 1). Note that this figure is not meant to be limiting with regard to the present process and is included simply for non-limiting illustrative purposes.

The first embodiment of the present invention provides for a process as shown in FIG. 1 which includes a carbon dioxide removal unit 8 which includes a purge phase (sorbent bed 10.2). With further reference to FIG. 1, the process involves the generation of a hydrogen rich effluent by the treatment of one or more hydrocarbon feed streams (preferably natural gas) provided from a source 1 via line 2 in a reformer unit 3. The reformer unit 3 contemplated for use in the present invention is selected from a steam hydrocarbon reformer unit (preferably a steam methane reformer unit) or an autothermal reformer unit. Those skilled in the art will also recognize that the steam hydrocarbon reforming process or the autothermal reforming process and the equipment for carrying out each of these processes are known in the art. Accordingly, the present invention is not intended to be limited by the type of steam hydrocarbon reformer unit or the type of autothermal reforming unit used. Each of these processes is carried out at a pressure that typically ranges from about 20 bar to about 40 bar. The one or more hydrocarbon feed streams are typically introduced into the reformer unit 3 from line 2 along with steam that has been added from line 4 to the one or more hydrocarbon feed streams upstream of the reformer unit 3. Regardless of the reformer unit 3 utilized, the reaction product from the reformer unit 3 is principally a hydrogen rich effluent that contains hydrogen, carbon monoxide, methane, water vapor and carbon dioxide in proportions close to equilibrium amounts at elevated temperature and pressure (hereinafter collectively referred to as “hydrogen rich effluent”).

In the second step of the process of the present invention, the hydrogen rich effluent obtained from the reformer unit 3 is treated in a water gas shift reactor 6 to further enrich the hydrogen content of the hydrogen rich effluent and to also increase the carbon dioxide content in the hydrogen rich effluent by oxidizing a portion of the carbon monoxide present in the effluent to carbon dioxide thereby obtaining a water gas shift effluent. In this embodiment, the hydrogen rich effluent stream is introduced via line 5 into the water gas shift reactor 6 (which can contain a variety of stages or one stage; stages not shown) to form additional hydrogen and carbon dioxide. Note that additional steam may also be added (not shown) upstream of the water gas shift reactor 6 along line 5. The result is a water gas shift effluent that is also at high temperature/high pressure. The conditions under which the water gas shift reaction is carried out are well known to those skilled in the art. Accordingly, the present process is not meant to be limited with regard to a specific water gas shift reactor 6 or the process for carrying out the reaction in the water gas shift reactor 6. Accordingly, any water gas shift reactor 6 known in the art may be used in the process of the present invention.

In the third step of the present process, the water gas shift effluent that is obtained from the water gas shift reactor 6 is subjected to treatment in a carbon dioxide removal unit 8 that contains at least four sorbent beds 10 (individually labeled as 10.1, 10.2, 10.3, and 10.4), that are configured to allow for the use of a magnesium based sorbent 11 in a loose form with each of the sorbent beds 10 corresponding to a different phase in the first embodiment of the present process for the removal of the carbon dioxide from the stream utilizing the loose sorbent.

The sorbent 11 that is utilized in the process of the present invention is highly selective for carbon dioxide and is selected from magnesium based sorbents, more particularly magnesium hydroxide sorbents. The sorbent 11 in this fluidized/moving bed process is typically found in the form of small beads, granules, or crumbs of the sorbent 11 that are small enough in size to allow for these forms to be easily fluidized. Of these sorbents 11, the most preferred with regard to the present process are the magnesium hydroxide sorbent such as those disclosed in U.S. Pat. No. 7,314,847 and Novel Regenerable Magnesium Hydroxide Sorbent for CO₂ Capture, the full contents of each incorporated herein.

The magnesium based sorbent utilized in the process of the present invention is in a moving/fluidized form. Those skilled in the art of moving/fluidized beds will recognize that fluidization requires the gas stream to lift and move the solids, and special separators to separate the gas from the solids. Similarly, moving beds require moving grates, conveyors, etc. Such various manners of fluidization are well known to those skilled in the art therefore details are not included herein. The ability to move the sorbent 11 around makes it a continuous and steady state process, as compared to a batch process for fixed beds.

Those skilled in the art will recognize that the present process may be carried out using any number of sorbent beds 10 provided that at least one bed 10 corresponds to each phase of the process and that flow between such beds 10 can be controlled by any means known in the art such as through strategically placed lines and valves. In one preferred embodiment of the present process as set forth in FIG. 1, the schematic configuration utilized with regard to the carbon dioxide removal unit 8 is a configuration that contains at least four sorbent beds 10 with at least one sorbent bed 10 utilized in each phase of the process.

The sorbent 11 passes through the series of sorbent beds 10 which correspond to the various phases of carbon dioxide removal within the carbon dioxide removal system: the sorption phase (sorbent bed 10.1), the purge phase (sorbent bed 10.2), the carbon dioxide release phase (sorbent bed 10.3) and the rehydroxylation phase (sorbent bed 10.4). With regard to the example set forth in FIG. 1, the water gas shift effluent from line 7 is typically injected into the first sorbent bed 10.1 along with a supply of sorbent 11 via line 12. Note the method of conveying sorbent by gas is well known to those familiar with the art, and is not discussed or shown herein. Similarly, separation of gas from sorbent, shown as 13.1, 13.2, and 13.3 in FIG. 1 is well known to those familiar with the art.

As noted, the treatment of the syngas stream in the sorbent beds 10 involves four phases: a sorption phase, a purge phase, a carbon dioxide release phase and a sorbent rehydroxylation phase. The first of these phases, the sorption phase, involves introducing the water gas shift effluent via line 7 into the first sorbent bed 10.1 in the carbon dioxide removal unit 8 along with the magnesium based sorbent 11 obtained from the sorbent source 14 or recycled from sorbent bed 10.4 (discussed further herein). As the sorbent 11/water gas shift effluent pass through the first sorbent bed 10.1, the carbon dioxide in the syngas stream selectively reacts with the sorbent 11 resulting in the production of a mixture comprising reacted sorbent 11 and a carbon dioxide deficient stream. The carbon dioxide affixes to the sorbent 11 as the stream passes through the fluidized sorbent bed 10.1.

Note that the residence time of sorbent 11 in the first sorbent bed 10.1 will depend upon the particular sorbent 11 utilized. As used herein, with regard to the sorption phase, the term “capacity” and phrase “high capacity” each refer to the amount of carbon dioxide that the sorbent 11 will remove from the water gas shift effluent. More specifically, the term “capacity” and phrase “high capacity” each refer to the amount of reactive sites (hydroxyl sites) of the sorbent 11 that react with carbon dioxide.

The balance of the unreacted water gas shift effluent (the carbon dioxide depleted stream) along with reacted sorbent 11 exits the sorbent bed 10.1 via line 15 and is then passed to a phase separator 13.1 where carbon dioxide depleted stream is separated from the reacted sorbent 11. The carbon dioxide depleted stream comprises both hydrogen and carbon monoxide in high concentrations and is essentially carbon dioxide free. As used herein, the phrase “essentially carbon dioxide free” refers to a stream that contains less than about 1.0% carbon dioxide, preferably less than about 0.5% carbon dioxide and even more preferably, less than about 0.1% carbon dioxide. However, as noted before, those skilled in the art will recognize that these essentially carbon dioxide free streams often contain residual amounts of other components that may be present in the original water gas shift effluent to be treated as well.

Note that the temperature at which the water gas shift effluent is introduced into the sorbent bed 10.1 will depend upon the specific sorbent 11 utilized as well as the conditions under which the reforming reaction is carried out. Typically, the water gas shift effluent will be introduced into the first sorbent bed 10.1 at a temperature that ranges from about 100° C. to about 315° C. and at a pressure that ranges from about 10 bar to about 40 bar, preferably at a temperature that ranges from about 180° C. to about 300° C. and at a pressure from about 20 bar to about 40 bar.

With regard to the actual chemical reaction taking place with regard to the sorbent 11, the sorbent 11 reacts with the carbon dioxide in the water gas shift effluent to produce a carbonate and water. For example, in the case of magnesium hydroxide the reaction is:

Mg(OH)₂+CO₂→MgCO₃+H₂O

The magnesium hydroxide reacts with the carbon dioxide to yield magnesium carbonate and water. While a majority of the carbon dioxide present in the water gas shift effluent will react with the magnesium hydroxide sorbent 11 to form a carbonate, a small amount of the carbon dioxide will remain unreacted. Generally greater than 90% of the carbon dioxide in the water gas shift effluent will be removed from the water gas shift effluent by the sorbent 11, preferably greater than 95% and even more preferably greater than 99%.

As noted above, the phase separator 13.1 separates the sorbent from the remaining components of the water gas shift effluent. As used herein with regard to the sorption phase, the phrase “remaining components” refers to the hydrogen, carbon monoxide, methane, water vapor and other components as defined hereinbefore (also referred to as the carbon dioxide depleted stream). In addition, the carbon dioxide depleted stream may also include a small amount of the carbon dioxide that does not react with the sorbent 11. The carbon dioxide depleted stream is sent via line 16 to the hydrogen pressure swing adsorption unit 33 for further treatment to produce a purified hydrogen stream.

The next phase in the carbon dioxide removal unit 8 is the purging of the sorbent 11 in order to remove those nonspecifically entrained components. The sorbent 11 that results from separator 13.1 is introduced into a second sorbent bed 10.2 from line 17 along with high pressure superheated steam from line 9. As a result, the reacted sorbent 11 is purged of the nonspecifically trapped components thereby producing a purge effluent gas. As noted previously, it is desirable to include the purge phase of the process only when a very high purity carbon dioxide product is desired. The amount of steam required for the purge may not be adequate to fluidize the sorbent 11 in bed 10.2 and therefore it may be preferential to use a moving bed to remove the sorbent 11 from the bottom of the bed 10.2.

The purge effluent gas is withdrawn from the second sorbent bed 10.2 via line 18 for example through a reversible flow conduit (not shown) and passed on to a thermo-compressor 19. The purge effluent gas is then recycled via line 20 along with the superheated steam injected via line 39 into the thermo-compressor 19 to the reformer unit 3. Accordingly, the thermal energy in hot purge effluent gas is utilized in the reforming step. This purge effluent gas which contains hydrogen, carbon monoxide and methane is used as a supplemental feed to maximize production of hydrogen and carbon dioxide. Note that once the purge effluent gas is separated from the purged sorbent 11, the purged sorbent 11 is then passed to the third sorbent bed 10.3 via line 21 for the next phase of treatment in the carbon dioxide removal unit 8—the carbon dioxide release phase.

In the third phase of treatment, the carbon dioxide is released from the sorbent 11 in the third sorbent bed 10.3 producing a high purity carbon dioxide stream that is also at high pressure and high temperature. This is accomplished by increasing the temperature of the purged sorbent 11 in a first heat exchanger 22 and within the third sorbent bed 10.3. A portion of the carbon dioxide recycle stream via line 23 can be added along with steam via line 9 to provide additional gas flow required for fluidization of the sorbent bed 10.3. The increase in temperature of the third sorbent bed 10.3 may be achieved in three ways or combinations thereof. The temperature of the superheated steam stream provided via line 9 can be increased, the temperature of the recycle carbon dioxide provided via line 23 can be increased through the use of a third heat exchanger 24, and/or by additional heating means such as an indirect heat exchanger 25 may be used to increase the temperature of the purged sorbent 11 in the third sorbent bed 10.3 from about 180° C. to about 315° C. to from about 350° C. to about 420° C. In each of these cases, the increase in temperature is to allow for the release of carbon dioxide from the sorbent 11 thereby producing a carbon dioxide stream that is not only hot but also wet. The pressure within the third sorbent bed 10.3 at this point is generally slightly below the pressure in the second phase (the second sorbent bed 10.2).

The mixture of sorbent 11 and the carbon dioxide gas steam is then passed along via line 26 to a second phase separator 13.2 where the carbon dioxide gas is separated from the sorbent 11. The carbon dioxide gas stream is then routed for use as product via line 27 and line 34 or recycled back to the sorbent bed 10.2 via line 23.

The sorbent 11 is passed along line 28 to a final and fourth sorbent bed 10.4 for the rehydroxylation of the sorbent 11 to take place. More specifically, with regard to the sorbent 11, the carbon dioxide is released from the carbonate formed in the sorption phase and MgO is formed which is sent to the fourth sorbent bed 10.4 for rehydroxylation to take place. In line with the previous example, this is demonstrated by the reactions as follows:

MgCO₃→MgO+CO₂

MgO+H₂O→Mg(OH)₂

As shown in this example, during the release portion of this phase, the magnesium carbonate is subjected to the noted temperatures (from about 350° C. to about 420° C.) to yield magnesium oxide and carbon dioxide.

Within the fourth sorbent bed 10.4, the sorbent 11 is subjected to a reduced temperature to allow for the rehydroxylation. More specifically, the temperature is from about 200° C. to about 300° C. in order to allow for the rehydroxylation of the sorbent 11. During rehydroxylation, the sorbent 11 in the sorbent bed 10.4 is being contacted with the steam and/or any other moisture containing stream supplied via line 38. The sorbent may be cooled indirectly in a heat exchanger 29 upstream of sorbent bed 10.4.

During the rehydroxylation portion of this phase, magnesium oxide reacts (via hydroxylation) with water present in the steam or other moisture containing stream to yield magnesium hydroxide (a regenerated sorbent). The mixture of steam and/or any other moisture containing stream and the rehydroxylated sorbent 11 is withdrawn from the fourth sorbent bed 10.4 via line 30 and passed to the third phase separator 13.3 where they are separated and the rehydroxylated sorbent 11 is recycled via line 31 to line 12 where it can be reutilized to treat the water gas shift effluent being injected into the first sorbent bed 10.1. The remaining steam and/or other moisture containing stream is withdrawn via line 32 and either condensed or used elsewhere.

The carbon dioxide stream produced can be utilized in two manners. First, as noted above, all or a portion of the carbon dioxide stream can be recycled via line 23 to be used as a supplemental gas for fluidizing sorbent in bed 10.3. Note that prior to the carbon dioxide stream being recycled to the sorbent bed 10.3, the pressure of carbon dioxide may need to be raised by a thermo-compressor 36 which is supplied with additional high pressure steam via line 37. The thermo-compressor 36 uses from 20 to 60 bar high pressure steam as motive force. Those skilled in the art will recognize the limitations of the thermo-compressors 36 in terms of available pressure rise. The remaining portion of the carbon dioxide stream can be utilized as carbon dioxide product as this stream is of high purity. This carbon dioxide product stream can be withdrawn for further use via line 34.

As noted above, the carbon dioxide depleted gas stream obtained in the first phase (the sorption phase) may be withdrawn and used as product or routed for further treated in the hydrogen pressure swing adsorption unit 33. Any hydrogen pressure swing adsorption unit 33 know in the art may be utilized for the purification of the hydrogen. Accordingly, the present invention is not meant to be limited by the hydrogen pressure swing adsorption unit 33 utilized. As a result of the further treatment of the carbon dioxide depleted gas stream, it is possible to produce a high purity hydrogen stream.

A still further embodiment of the present invention involves modifying the carbon dioxide removal unit 8 to allow for the recovery of the heat of sorption and the heat of rehydroxylation in the sorbent beds 10.1 and 10.4 and to supply heat in sorbent bed 10.3 for the release of carbon dioxide. The hot heat transfer media can be utilized to transfer heat within the carbon dioxide removal unit 8 or exchange heat between the carbon dioxide removal unit 8 and the reformer unit 3 or water gas shift reactor 5. The heat transfer media can also be used to generate high pressure steam to be utilized in the carbon dioxide removal unit 8 or reformer unit 3 or water gas shift reactor 5. The modified carbon dioxide removal unit 8 would therefore comprise at least four sorbent beds 10.1, 10.2, 10.3 and 10.4 containing sorbent 11 and a series of heat transfer surfaces 25 that run through at least beds 10.1 (the sorption phase), 10.3 (the carbon dioxide release phase), and 10.4 (the rehydroxylation phase). The heat transfer surfaces would each have a media running there through to adsorb the heat of sorption or the heat of rehydroxylation, and provide heat for carbon dioxide release. More specifically, the heated transfer media would be used to exchange heat between the carbon dioxide removal unit 8 and various process streams of the reformer unit 3, or generate high pressure steam for the carbon dioxide removal unit 8. A variety of different types of heat transfer media are available to be utilized in this manner. Examples of such heat transfer media include, but are not limited to, a molten carbonate salt mixture or any inorganic or organic compound with a boiling point that ranges from about 250° C. to about 350° C.

The second embodiment of the present process is similar in nature to the first embodiment shown in FIG. 1 with the exception that this embodiment only contains three phases (embodiment not shown), since no purge phase being necessary. Accordingly, only a carbon dioxide depleted stream and a high temperature/high pressure carbon dioxide rich stream are produced. With regard to this particular embodiment, as the sorbent is not purged, there will likely be residual components in the carbon dioxide product stream as these residual components are not removed prior to the release of the carbon dioxide from the reacted sorbent 11.

### ELEMENTS OF THE FIGURES

1 hydrocarbon feed stream source
2 line providing the hydrocarbon feed stream source to the reformer unit
3 reformer unit
4 line for adding steam
5 line for introducing the hydrogen rich effluent into the water gas shift reactor
6 water gas shift reactor
7 line by which the water gas shift effluent is transported to the carbon dioxide removal unit
8 carbon dioxide removal unit
9 line for supplying superheated steam
10 sorbent bed
10.1 first sorbent bed
10.2 second sorbent bed
10.3 third sorbent bed
10.4 fourth sorbent bed
11 sorbent
12 line by which the water gas shift effluent is injected into the first sorbent bed along with sorbent
13.1 first phase separator
13.2 second phase separator
13.3 third phase separator
14 sorbent source
15 line by which the mixture of carbon dioxide depleted stream and sorbent exits the first sorbent bed
16 line by which the carbon dioxide depleted stream is sent to the hydrogen pressure swing adsorption unit
17 Line by which the sorbent from separator 13.1 is introduced into the second sorbent bed
18 line by which the purge effluent gas is withdrawn
19 thermo-compressor
20 line by which the purge effluent gas is recycled to the reformer unit
21 line by which the purged sorbent is passed to the third sorbent bed
22 first heat exchanger
23 line for recycling carbon dioxide to the third sorbent bed
24 third heat exchanger
25 indirect heat exchanger
26 line by which the mixture of sorbent and the carbon dioxide gas steam is passed along to the second phase separator
27 line by which carbon dioxide is routed from the second phase separator
28 line by which the sorbent is passed to the fourth sorbent bed
29 heat exchanger
30 line by which mixture of steam and/or any other moisture containing stream and the rehydroxylated sorbent is withdrawn from the fourth sorbent bed and sent to the third phase separator
31 line by which rehydroxylated sorbent is recycled back to line 12
32 line by which remaining steam and/or other moisture containing stream is withdrawn and sent to be either condensed or used elsewhere
33 hydrogen pressure swing adsorption unit
34 line for withdrawing carbon dioxide as product
36 thermo-compressor
37 line to supply heat to the thermo-compressor 36
38 line for supplying steam and/or any other moisture containing stream to the fourth sorbent bed
39 line by which steam is supplied to the thermo-compressor 19

1. A process for recovering hydrogen and high pressure high purity carbon dioxide from one or more hydrocarbon feed streams, said process comprising:
a) introducing one or more hydrocarbon feed streams into a reformer unit to generate a hydrogen rich effluent that also contains carbon monoxide, carbon dioxide, methane and water vapor;
b) treating the hydrogen rich effluent in a water gas shift reactor thereby obtaining a water gas shift effluent;
c) subjecting the water gas shift effluent to treatment in a carbon dioxide removal unit that contains at least a first sorbent bed, a second sorbent bed, and a third sorbent bed and a fourth sorbent bed, the first, second, third and fourth sorbent beds being connected in series and being configured to allow for the passage of a gas and a magnesium based sorbent that is highly selective for carbon dioxide through the series of sorbent beds, the treatment involving:
i) a sorption phase in which the water gas shift effluent and the magnesium based sorbent are introduced into the first sorbent bed at a temperature from about 100° C. to about 315° C. and a pressure from about 10 to about 40 bar, the carbon dioxide in the water gas shift effluent selectively reacting with the sorbent and a portion of the remaining components of the water gas shift effluent nonspecifically reacting with the sorbent to produce a mixture comprising reacted sorbent and a carbon dioxide depleted stream as the water gas shift effluent and sorbent pass through the first sorbent bed,
ii) a first separation in which the mixture comprising reacted sorbent and the carbon dioxide depleted stream pass from the first sorbent bed and through a first phase separator to separate the reacted sorbent from the carbon dioxide depleted stream,
iii) a purge phase in which the reacted sorbent and a high pressure superheated steam are each introduced into the second sorbent bed in order to purge the reacted sorbent of the nonspecifically trapped components from the water gas shift effluent thereby producing a mixture of purged sorbent which is withdrawn from a bottom of the second sorbent bed and a purge effluent gas which is withdrawn from a top of the second sorbent bed;
iv) a carbon dioxide release phase in which the purged sorbent is introduced into the third sorbent bed along with superheated steam, the high pressure superheated steam used along with indirect heat to raise the temperature of the third sorbent bed to of between 350° C. and 420° C. thereby allowing for the release of the carbon dioxide from the purged sorbent to produce a carbon dioxide deficient sorbent and a wet, high temperature carbon dioxide rich stream;
v) a second separation in which the carbon dioxide deficient sorbent and the carbon dioxide rich stream are passed from the third sorbent bed and through a second phase separator to separate the carbon dioxide deficient sorbent and a carbon dioxide product stream;
vi) a rehydroxylation phase in which the carbon dioxide deficient sorbent is introduced into the fourth sorbent bed where the temperature is lowered to about 200° C. to 300° C. and the carbon dioxide deficient sorbent is contacted with steam and/or a moisture containing stream to allow for the rehydroxylation of the sorbent,
vii) a third separation in which the rehydroxylated sorbent and the steam and/or a moisture containing stream are passed from the fourth sorbent bed and through a third phase separator to separate the steam and/or a moisture containing stream from the rehydroxylated sorbent;
d) recycling the rehydroxylated sorbent to the first sorbent bed;
e) recycling at least a portion of the wet high temperature carbon dioxide rich stream to the sorbent bed during the carbon dioxide release phase and withdrawing any remaining portion of the high temperature, high pressure carbon dioxide rich stream as carbon dioxide product for further use; and
f) recycling the purge effluent gas along with the high pressure superheated steam to the hydrocarbon feed stream that is to be introduced into the reformer unit.

2. The process of claim 1, wherein the reformer unit is selected from a steam hydrocarbon reformer unit and an autothermal reformer unit.

3. The process of claim 2, wherein the reformer unit is a steam methane reformer unit.

4. The process of claim 2, wherein the sorbent is passed through a heat exchanger prior to being introduced into the third sorbent bed in order to raise the temperature of the sorbent.

5. The process of claim 2, wherein the sorbent is passed through a heat exchanger prior to being introduced into the fourth sorbent bed in order to lower the temperature of the sorbent.

6. The process of claim 2, wherein a portion of the hot carbon dioxide product stream is used to further fluidize the sorbent in the third sorbent bed.

7. The process of claim 2, wherein the carbon dioxide removal unit contains more than one sorbent bed corresponding to each phase of the carbon dioxide removal.

8. The process of claim 2, wherein the magnesium based sorbent used in the sorbent beds is magnesium hydroxide.

9. The process of claim 8, wherein the pressure in all sorbent beds is relatively the same.

10. The process of claim 3, wherein each of the sorbent beds includes a means for heating and cooling the sorbent beds.

11. The process of claim 10, wherein the means for heating and cooling the sorbent bed includes a series of heat transfer surfaces that run through the sorbent beds, the heat transfer surfaces having disposed therein a heated transfer media which becomes heated due to the heat generated with sorption and rehydroxylation.

12. The process of claim 11, wherein the heated transfer media is used to generate high pressure steam for the carbon dioxide removal unit or the reformer unit or water gas shift reactor.

13. The process of claim 12, wherein the heat transfer media which has recovered the heat from the process streams of the reformer unit or water gas shift reactor is used to heat the sorbent.

14. The process of claim 12, wherein heated transfer media which has recovered the heat to cool the sorbent is used to heat the process streams of the reformer unit.

15. The process of claim 12, wherein the heated transfer media is molten carbonate salt mixture.

16. The process of claim 12, wherein the heated transfer media is an inorganic or organic compound with a boiling point that ranges about 250° C. to about 350° C.

17. The process of claim 1, wherein the magnesium based sorbent used in the sorbent beds is magnesium hydroxide.

18. The process of claim 3, wherein prior to a portion of the wet high temperature, high pressure carbon dioxide rich stream being recycled to the sorbent bed, the carbon dioxide rich stream is passed through a thermo-compressor while high pressure steam is introduced as motive steam for the thermo-compressor.

19. A process for recovering hydrogen and high pressure high purity carbon dioxide from one or more hydrocarbon feed streams, said process comprising:
a) introducing one or more hydrocarbon feed streams into a reformer unit to generate a hydrogen rich effluent that also contains carbon monoxide, carbon dioxide, methane and water vapor;
b) treating the hydrogen rich effluent in a water gas shift reactor thereby obtaining a water gas shift effluent;
c) subjecting the water gas shift effluent to treatment in a carbon dioxide removal unit that contains at least a first sorbent bed, a second sorbent bed, and a third sorbent bed, the first, second, and third sorbent beds being connected in series and being configured to allow for the passage of a gas and a magnesium based sorbent that is highly selective for carbon dioxide through the series of sorbent beds, the treatment involving:
i) a sorption phase in which the syngas stream and the magnesium based sorbent are introduced into the first sorbent bed at a temperature from about 100° C. to about 315° C. and a pressure from about 10 to about 40 bar, the carbon dioxide in the syngas stream selectively reacting with the sorbent to produce a mixture comprising reacted sorbent and a hydrogen/carbon monoxide gaseous rich stream as the syngas stream and sorbent pass through the first sorbent bed,
ii) a first separation in which the mixture comprising reacted sorbent and a hydrogen/carbon monoxide gaseous rich stream pass from the first sorbent bed and through a first phase separator to separate the reacted sorbent from the hydrogen/carbon monoxide gaseous rich stream,
iii) a carbon dioxide release phase in which the reacted sorbent is introduced into the second sorbent bed along with superheated steam, the superheated steam used along with indirect heat to raise the temperature of the second sorbent bed to of between 350° C. and 420° C. thereby allowing for the release of the carbon dioxide from the reacted sorbent to produce a carbon dioxide deficient sorbent and a wet, high temperature carbon dioxide rich stream;
iv) a second separation in which the carbon dioxide deficient sorbent and the carbon dioxide rich stream are passed from the second sorbent bed and through a second phase separator to separate the carbon dioxide deficient sorbent and the carbon dioxide product stream;
v) a rehydroxylation phase in which the carbon dioxide deficient sorbent is introduced into a the fourth sorbent bed where the temperature is lowered to about 200° C. to 300° C. and contacted with steam and/or a moisture containing stream to allow for the rehydroxylation of the sorbent,
vii) the third separation in which the rehydroxylated sorbent and the steam and/or a moisture containing stream are passed from the fourth sorbent bed and through a third phase separator to separate the steam and/or a moisture containing stream from the rehydroxylated sorbent;
c) recycling the rehydroxylated sorbent to the first sorbent bed; and
d) recycling at least a portion of the wet high temperature, high pressure carbon dioxide rich stream to the sorbent bed during the carbon dioxide release phase and withdrawing any remaining portion of the high temperature, high pressure carbon dioxide rich stream as carbon dioxide product for further use.

20. The process of claim 19, wherein the syngas producing unit is selected from a steam hydrocarbon reformer unit, an autothermal reformer unit, and a partial oxidation unit.

21. The process of claim 20, wherein the syngas producing unit is a steam methane reformer unit.

22. The process of claim 20, wherein the sorbent is passed through a heat exchanger prior to being introduced into the third sorbent bed in order to raise the temperature of the sorbent.

23. The process of claim 20, wherein the sorbent is passed through a heat exchanger prior to being introduced into the fourth sorbent bed in order to lower the temperature of the sorbent.

24. The process of claim 20, wherein a portion of the hot carbon dioxide product stream is used to further fluidize the sorbent in the third sorbent bed.

25. The process of claim 20, wherein the carbon dioxide removal unit contains more than one sorbent bed corresponding to each phase of the carbon dioxide removal.

26. The process of claim 20, wherein the magnesium based sorbent used in the one or more sorbent beds is magnesium hydroxide.

27. The process of claim 26, wherein the pressure in all sorbent beds is relatively the same.

28. The process of claim 21, wherein each of the sorbent beds includes a means for heating and cooling the sorbent beds.

29. The process of claim 28, wherein the means for heating and cooling the sorbent bed includes a series of heat transfer surfaces that run through the sorbent beds, the heat transfer surfaces having disposed therein a heated transfer media which becomes heated due to the heat generated with sorption and rehydroxylation.

30. The process of claim 29, wherein the heated transfer media is used to generate high pressure steam for the carbon dioxide removal unit or the reformer unit or water gas shift reactor.

31. The process of claim 29, wherein the heated transfer media which has recovered heat from the process stream of the reformer unit or the water gas shift reactor is used to heat the sorbent.

32. The process of claim 29, wherein the heated transfer media which has recovered the heat to cool the sorbent is used to heat the process streams of the reformer unit.

33. The process of claim 30, wherein the heated transfer media is molten carbonate salt mixture.

34. The process of claim 30, wherein the heated transfer media is an inorganic or organic compound with a boiling point that ranges about 250° C. to about 350° C.

35. The process of claim 19, wherein the magnesium based sorbent used in the one or more sorbent beds is magnesium hydroxide.

36. The process of claim 19, wherein prior to a portion of the wet high temperature, high pressure carbon dioxide rich stream being recycled to the hydrocarbon feed stream to be introduced into the steam hydrocarbon reformer unit, the carbon dioxide rich stream is passed through a thermo-compressor for recompression using high pressure steam as the motive.
